(19) United States
(12) Patent Application Publication
(10) Pub. No.: US 2019/0354640 A1
(43) Pub. Date: Nov. 21, 2019

(54) Kitchen Construction Apparatus and Method

(71) Applicant: Dollypup Productions, LLC, Bowie, MD (US)

(72) Inventor: Christopher Allen Huebner, Bowie, MD (US)

(21) Appl. No.: 15/983,314

(22) Filed: May 18, 2018

(51) Int. Cl. G06F 17/50

(52) U.S. Cl. CPC G06F 17/5004

(57) ABSTRACT

These various embodiments pertain to constructing a kitchen in accordance with a final layout design for the kitchen. By one approach this includes using a control circuit to provide a user with an opportunity to automatically construct a narrative that recounts design changes between a first layout design for the kitchen and a second layout design for the kitchen. Upon detecting the user's assertion of that opportunity, the control circuit automatically constructs that narrative and outputs that determined narrative to the user. Upon ultimately outputting a final layout design for the kitchen, these teachings contemplate actually and physically using that final layout design for the kitchen to physically construct the kitchen. By one approach the aforementioned narrative comprises a text-based narrative.

### TECHNICAL FIELD

These teachings relate generally to kitchens and more particularly to the construction of commercial food service kitchens.

### BACKGROUND

Kitchens are a well-understood area of prior art endeavor. That said, modern commercial kitchens often comprise complicated and unique-to-themselves structures. The foregoing complexities are owing, at the least, to a vast variety of available appliances (each having their own specifications and installation and usage requirements), the purpose and intended usage of the kitchen (including preferences of the cooking personnel), building code requirements, and the opportunities and/or limitations that characterize a given architectural design.

Computer-aided design tools are available to help kitchen designers properly configure a given kitchen. Such tools can greatly facilitate creating an accurate and easily-understood and visualized layout design plan for a commercial kitchen. Unfortunately, existing tools in these regards do not adequately meet the needs and requirements of all application settings. As a result, confusion and delay with respect to reaching a final approved design and physically constructing the kitchen are amongst the repercussions of such shortcomings.

### BRIEF DESCRIPTION OF THE DRAWINGS

The above needs are at least partially met through provision of the kitchen construction apparatus and method described in the following detailed description, particularly when studied in conjunction with the drawings, wherein:

FIG. 1 comprises a block diagram as configured in accordance with various embodiments of these teachings;

FIG. 2 comprises a flow diagram as configured in accordance with various embodiments of these teachings;

FIG. 3 comprises an architectural design diagram as configured in accordance with various embodiments of these teachings;

FIG. 4 comprises a screen shot as configured in accordance with various embodiments of these teachings;

FIG. 5 comprises a top plan view of a layout design for a kitchen as configured in accordance with various embodiments of these teachings;

FIG. 6 comprises a top plan view of a layout design for a kitchen as configured in accordance with various embodiments of these teachings;

FIG. 7 comprises a three-dimensional perspective view of a section of a layout design for a kitchen as configured in accordance with various embodiments of the invention;

FIG. 8 comprises a three-dimensional perspective view of a section of a layout design for a kitchen as configured in accordance with various embodiments of these teachings;

FIG. 9 comprises a top plan view of a section of a layout design for a kitchen as configured in accordance with various embodiments of the invention;

FIG. 10 comprises a three-dimensional perspective view of a section of a layout design for a kitchen as configured in accordance with various embodiments of these teachings;

FIG. 11 comprises a top plan view of a section of a layout design for a kitchen as configured in accordance with various embodiments of these teachings;

FIG. 12 comprises a three-dimensional perspective view of a section of a layout design for a kitchen as configured in accordance with various embodiments of these teachings;

FIG. 13 comprises a top plan view of a section of a layout design for a kitchen as configured in accordance with various embodiments of these teachings;

FIG. 14 comprises a top plan view of a section of a layout design for a kitchen as configured in accordance with various embodiments of these teachings;

FIG. 15 comprises a top plan view of a section of a layout design for a kitchen as configured in accordance with various embodiments of these teachings;

FIG. 16 comprises a top plan view of a section of a layout design for a kitchen as configured in accordance with various embodiments of these teachings;

FIG. 17 comprises an elevational two-dimensional view of a section of a layout design for a kitchen as configured in accordance with various embodiments of these teachings;

FIG. 18A comprises a three-dimensional perspective view of a section of a layout design for a kitchen as configured in accordance with various embodiments of these teachings;

FIG. 18B comprises a screen shot as configured in accordance with various embodiments of these teachings;

FIG. 19 comprises a flow diagram as configured in accordance with various embodiments of these teachings;

FIG. 20 comprises a screen shot as configured in accordance with various embodiments of these teachings;

FIG. 21 comprises a view of a thumbnail image as configured in accordance with various embodiments of these teachings;

FIG. 22 comprises a screen shot as configured in accordance with various embodiments of these teachings;

FIG. 23 comprises a view of a report as configured in accordance with various embodiments of these teachings;

FIG. 24 comprises a flow diagram as configured in accordance with various embodiments of these teachings; and

FIG. 25 comprises a perspective view as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, these various embodiments pertain to constructing a kitchen in accordance with a final layout design for the kitchen. By one approach this includes using a control circuit to provide a user with an opportunity to automatically construct a narrative that recounts design changes between a first layout design for the kitchen and a second layout design for the kitchen. Upon detecting the user's assertion of that opportunity, the control circuit automatically constructs that narrative and outputs that determined narrative to the user. Upon ultimately outputting a final layout design for the kitchen, these teachings contemplate actually and physically using that final layout design for the kitchen to physically construct the kitchen.

By one approach the aforementioned narrative comprises a text-based narrative.

In furtherance of the foregoing, the control circuit can be further configured to capture layout designs (such as the aforementioned first layout design and second layout design) as corresponding data snapshots. These teachings are flexible in these regards and will accommodate, for example, capturing those data snapshots using a user-triggered data capture process and/or an automatic data capture process. As another example of flexibility in these regards, these teachings will accommodate also capturing corresponding graphic imagery of at least portions of the corresponding layout design of the kitchen such that at least some of the aforementioned data snapshots have a corresponding one of the graphic images.

So configured, numerous layout designs for the kitchen can be captured and those data snapshots then selected by the user in order to automatically prepare a corresponding narrative that describes changes between the two layout designs with respect to such things as electrical layout and specifications, plumbing layout and specifications, mechanical layout and specifications, and appliance selections and locations. These narratives, in turn, can greatly facilitate communicating changes within and amongst various stakeholders, including members of the layout design team, the architectural entity, the mechanical and electrical engineers, various construction contractors, inspectors, and the entity for whom the kitchen is being designed and built. This increase in efficiency, expediency, accountability, and accuracy can, in turn, lead to reduced cycle time and design plans that are more likely to be appropriately physically realized in an efficient and initially-correct manner.

Those skilled in the art will appreciate that the description of layout design changes for mechanical, electrical, and plumbing connections can represent changes that have not yet been made or authorized as well as changes that were previously effected. In addition the above-described narrative-creation process can be configured to facilitate, either automatically or at the behest of the user, automatic changes/updates to the mechanical, electrical, and plumbing design layouts to accord with the narrative itself.

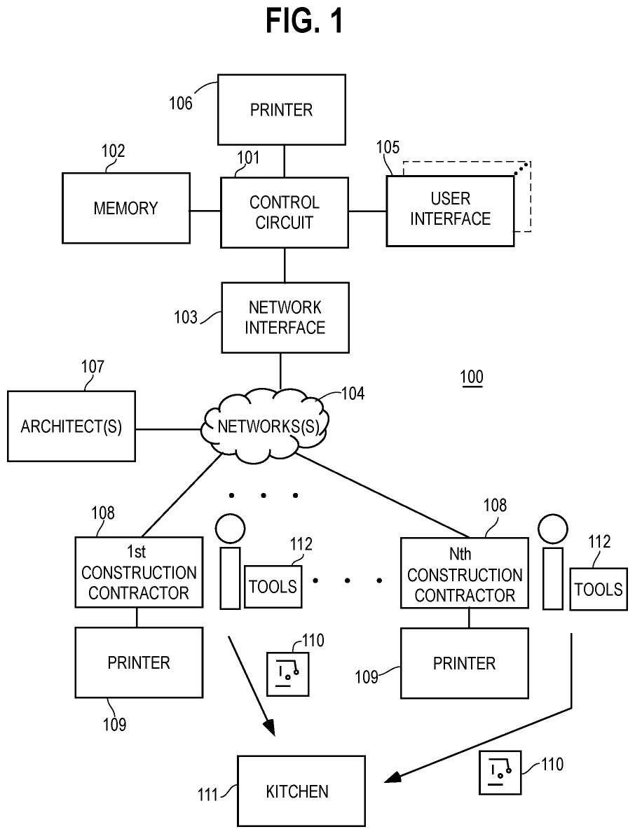

These and other benefits may become clearer upon making a thorough review and study of the following detailed description. Referring now to the drawings, and in particular to FIG. 1, an illustrative apparatus 100 that is compatible with many of these teachings will now be presented.

For the sake of an illustrative example it will be presumed here that a control circuit 101 carries out many, though not all, of the actions, steps, and/or functions of the process described herein. Being a “circuit,” the control circuit 101 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 101 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 101 is configured (for example, by using corresponding programming as will be well understood by those skilled in the art) to carry out one or more of the steps, actions, and/or functions described herein.

In this example the control circuit 101 operably couples to a memory 102. This memory 102 may be integral to the control circuit 101 or can be physically discrete (in whole or in part) from the control circuit 101 as desired. This memory 102 can also be local with respect to the control circuit 101 (where, for example, both share a common circuit board, chassis, power supply, and/or housing) or can be partially or wholly remote with respect to the control circuit 101 (where, for example, the memory 102 is physically located in another facility, metropolitan area, or even country as compared to the control circuit 101).

In addition to architectural information and layout designs for a given kitchen and other data described herein, this memory 102 can serve, for example, to non-transitorily store the computer instructions that, when executed by the control circuit 101, cause the control circuit 101 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

In this example the control circuit 101 also operably couples to a network interface 103. So configured the control circuit 101 can communicate with other elements via one or more intervening networks 104. Network interfaces, including both wireless and non-wireless platforms, are well understood in the art and require no particular elaboration here.

The control circuit 101 also operably couples to at least one user interface 105. This user interface 105 can comprise any of a variety of user-input mechanisms (such as, but not limited to, keyboards and keypads, cursor-control devices, touch-sensitive displays, speech-recognition interfaces, gesture-recognition interfaces, and so forth) and/or user-output mechanisms (such as, but not limited to, visual displays, audio transducers, and so forth) to facilitate receiving information and/or instructions from a user and/or providing information to a user.

In a typical application setting the control circuit 101 will also communicatively couple to a printer 106. This printer 106 may be located proximal to the control circuit 101 (for example, within a few feet of the control circuit 101 or within a shared room, shared floor, or shared building with the control circuit 101) or may be located remotely with respect to the printer. These teachings will accommodate a wide variety of printers including black-and-white printers as well as color printers. Such a printer 106 can serve, for example, to print intermediate or final layout kitchen designs, narratives (as described herein), and so forth as desired.

In a typical application setting, and as illustrated in FIG. 1, a number of other network elements and/or entities are also included. Examples include, but are not limited to, one or more architects 107 (having, for example, one or more computers that couple to the control circuit 101 via the aforementioned network 104) as well as computers 108 for one or more construction contractors (represented here as a first construction contractor through an nth construction contractor where “N” is an integer greater than 1). Examples of relevant construction contractors include, but are not limited to, electricians, plumbers, and mechanical tradesmen who each have their corresponding training, licensing, and tools of the trade 112.

In many cases these construction contractor computers 108 will couple to a corresponding printer 109. This can include printers that are locally disposed with respect to the corresponding computer or remotely located printers (as maintained and offered by, for example, a third-party printing service). These printers 109 can serve to print the final layout design 110 that the construction contractors utilize to guide their activities when physically building out the corresponding kitchen 111. (These teachings will also accommodate construction contractors who prefer to work with active devices, such as computer tablets and pads, to view the final layout design while on-site.)

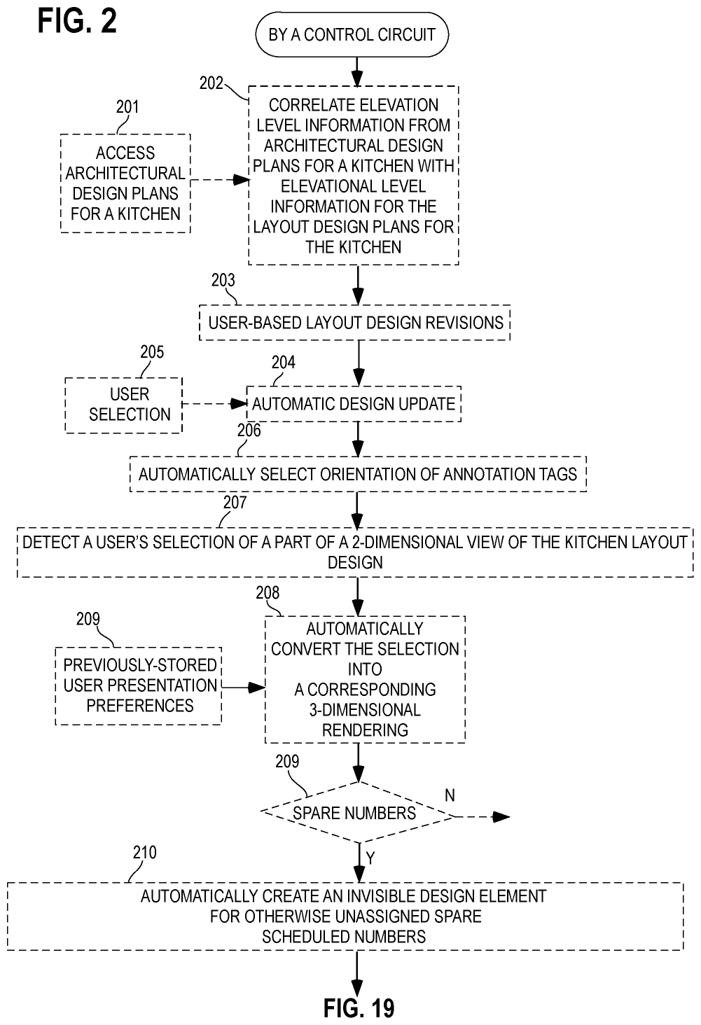

Referring now as well to FIG. 2, a process will be described having a number of steps including any number of optional steps. In a typical application many (but not all) of the steps illustrated in FIG. 2 are carried out by the aforementioned control circuit 101.

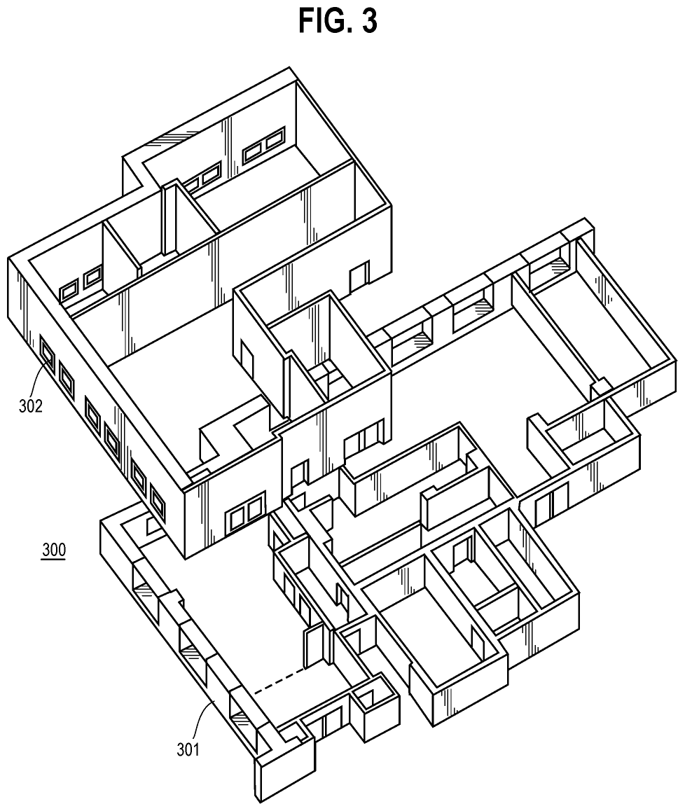

At optional block 201 the control circuit 101 accesses architectural design plans for a kitchen. FIG. 3 provides an illustrative example in these regards where the architectural design plan 300 includes structural building details for both a first level 301 and a second level 302 of a building. In a typical application setting the architectural design plans comprise one or more files formed and formatted by a corresponding computer aided design (CAD) program or programs of choice. For the sake of an illustrative example this description presumes use of the CAD program Revit as offered by Autodesk. (Those skilled in the art will understand and appreciate that the accessed architectural design does not consist of only the 3-D rendering shown in FIG. 3 but instead will constitute information that permits parsing and viewing the architectural information in any of a variety of ways including perspective views, planar views, elevational views, 2 and 3-dimensional views, and so forth.)

In the illustrative example of FIG. 3, the kitchen components are to be parsed and distributed over two different levels 301 and 302. In many cases the architectural design plans will specify an elevation that corresponds to each such level. In some cases that elevation will be presented with respect to sea level. In other cases the elevation will be presented with respect to some other reference level. It can therefore be useful or even necessary for purposes of the present process to match the elevation levels of the architectural design plan with the elevation levels for the layout design plans for the kitchen.

In the present example the control circuit 101 employs the program controlling the present process to link to the architectural design plan file with the original file being treated as a read-only file. (Revit allows such linking as a Revit tool.) This linked architectural design plan file will typically include a level schedule that specifies the aforementioned elevation levels. (In the present case the control circuit 101 extracts the relevant data without fully opening the architectural design plan file itself. In particular, the control circuit 101 can leverage an ability of the Revit application programmers interface to look up parameters such as these in this particular file without fully opening the complete design file.)

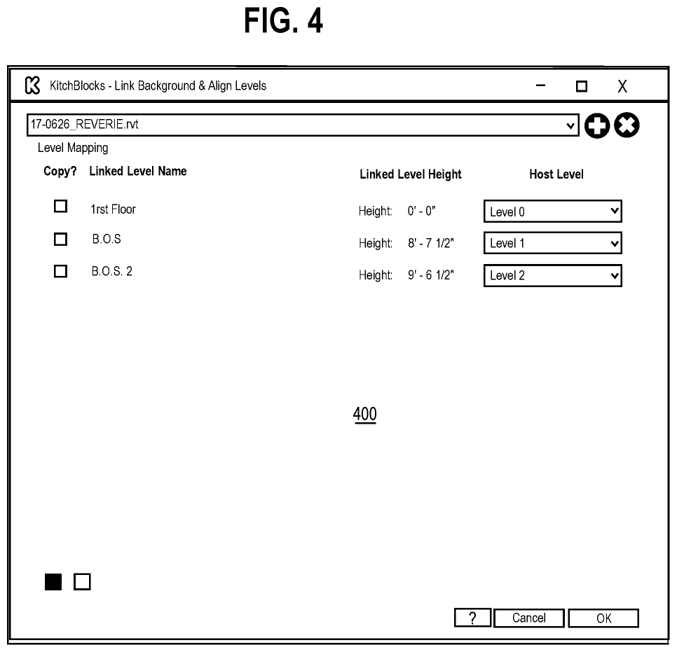

With momentary reference to FIGS. 2 and 4, at optional block 202 the control circuit 101 correlates the elevational level information from the architectural design plans for the kitchen with elevational level information for the layout design plans for the kitchen. Those skilled in the art will appreciate that one cannot merely create a new level at the desired height as such an approach will simply create a new (separate) level at the desired height. Instead, the control circuit 101 can automatically move existing levels that are identified in a corresponding graphical user interface (GUI) 400 to the corresponding identified levels of the architectural design plan.

Note that it may be useful or even necessary to conduct this elevation matching step even when the architectural design and the layout design for the kitchen contemplates only a single level, because the presumed elevations in both files may be initially different from one another and hence, by definition, at different levels from one another.

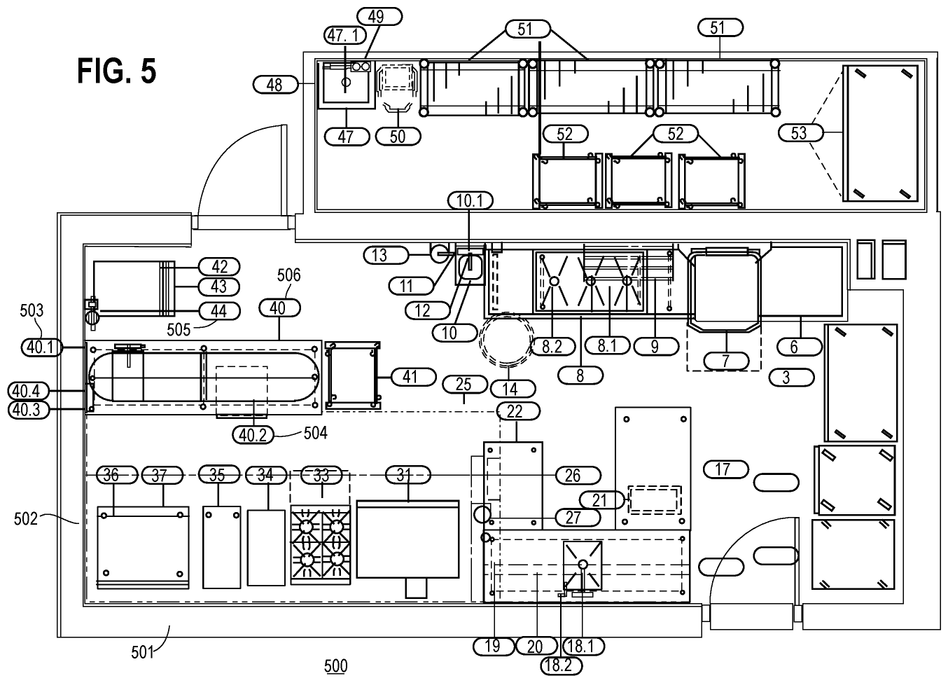

This process presumes creation of at least an initial layout design plan for the kitchen. FIG. 5 provides an illustrative example 500 in these regards. In this view the layout design plan for the kitchen constitutes a top plan view that depicts the walls of the architectural design (for example, as denoted by reference numerals 501 and 502) as well as various appliances and fixtures as selected and placed by the designer(s). These virtual elements of the layout are each individually selectable by the user and can be dragged to a particular location or removed as desired.

In this example the various appliances, fixtures, and other design elements of interest are denoted with an annotation tag. For example, a sink is denoted by annotation tag 18.1, a double-deck convection oven is denoted by annotation tag 31, a four-burner range and standard oven is denoted by annotation tag 33, a table filler is denoted by annotation tag 34, and a deep fat gas fryer is denoted by annotation tag 35.

It should be noted that the kitchen layout design 500 shown in FIG. 5 only represents a display of a part of the available design information. For example, although this kitchen layout design 500 shows where various appliances and fixtures are to be physically located within the architectural ambit of the “kitchen,” this particular presentation does not present other available information regarding, for example, electrical layout, plumbing layout, and mechanical layout. Those elements can be selectively included or excluded as desired. Examples of the foregoing are shown further below.

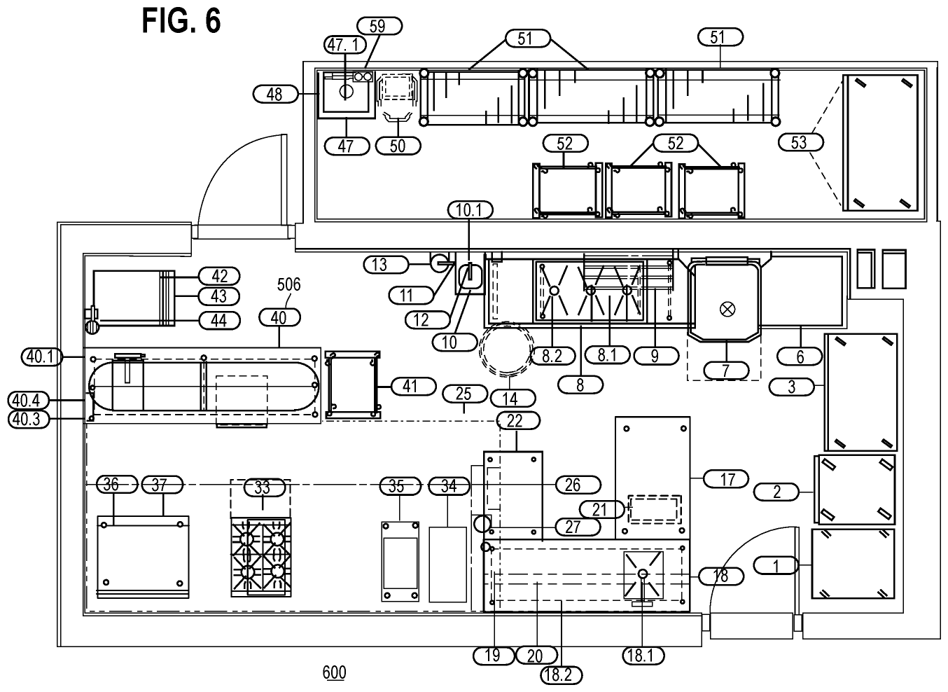

With continued reference to FIG. 2, this process will optionally accommodate user-based revisions to the layout design plan for the kitchen as shown at block 203. These teachings will accommodate a variety of user-based revisions including but not limited to user-based revisions to the design information regarding any one or more of electrical layout and specifications, plumbing layout and specifications, mechanical layout and specifications, and appliance and fixture selections and locations. FIG. 6 provides an illustrative example 600 in these regards. In this illustrative example the user moved the sink denoted by annotation tag 18.1 to a new position, removed the double-deck convection oven completely, and moved both the table filler denoted by annotation tab 34 and the deep fat gas fryer denoted by annotation tab 35 to new positions.

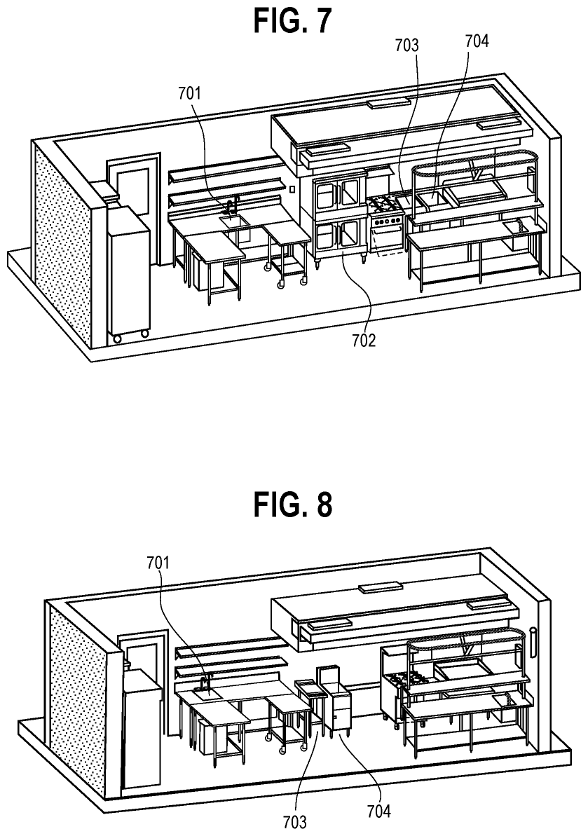

For the sake of clarity and to facilitate a better understanding of the foregoing, FIGS. 7 and 8 provide perspective views in these regards. In particular, FIG. 7 shows the appliance/fixture layout design of the kitchen prior to these user-based layout design revisions while FIG. 8 shows the appliance/fixture layout design of the kitchen following these user-based layout design revisions. In these figures the aforementioned sink is denoted by reference numeral 701, the double-deck convection oven is denoted by reference numeral 702, the table filler is denoted by reference numeral 703, and the deep fat gas fryer is denoted by reference numeral 704.

It will be appreciated that moving these appliances/fixtures can and will alter the electrical, plumbing, and mechanical layout needs of the design. For example, electrical outlets, plumbing connections, and gas outlets may need to be moved, removed, or added to accommodate moved, removed, or added appliances/fixtures. By one approach, such changes to the electrical, plumbing, and mechanical layout of the layout design for the kitchen can be individually entered by the user. If desired, however, these teachings will accommodate automatic design updates in these regards.

In particular, and as shown in FIG. 2 at block 204, this process can optionally accommodate automatically updating the design to add layout design revisions (such as electrical layout revisions, plumbing layout revisions, and mechanical layout revisions) to a kitchen layout design to accommodate such user-based layout design revisions. By one approach this automatic updating can occur immediately upon the user making a layout design revision with respect to the inclusion, exclusion, or modified placement of a particular appliance/fixture. By another approach, and as illustrated at block 205, this automatic updating can occur in response to the user specifically selecting the use of this capability (for example, via a corresponding selection button on the user interface 105). If desired, and as described below, this automated design update activity for mechanical, electrical, and plumbing layout revisions can also be supported in conjunction with the provision of a design narrative.

The control circuit 101 can be configured to base these automatic updates upon available information regarding the appliance/fixture in these regards as stored, for example, in the aforementioned memory 102. For example, such information for a particular appliance may specify requirements regarding electrical service that specify the required voltage and amperage, the type of outlet, and the height and lateral location of the outlet. So configured, when the user moves a particular electrically-powered appliance from a first position to a second position, the control circuit 101 can employ the foregoing information to provide for appropriate movement of the electrical service outlet for that particular appliance.

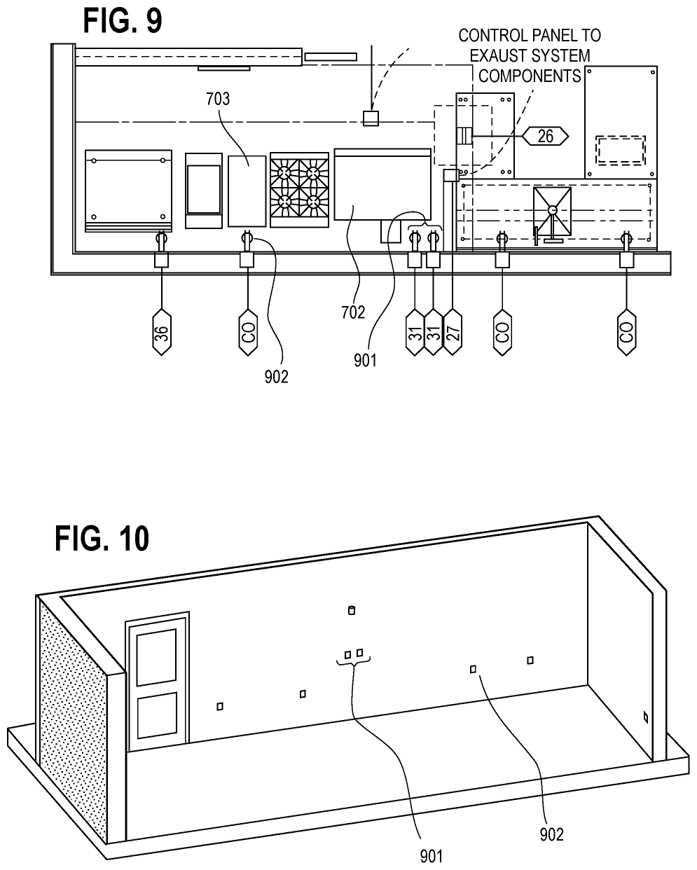

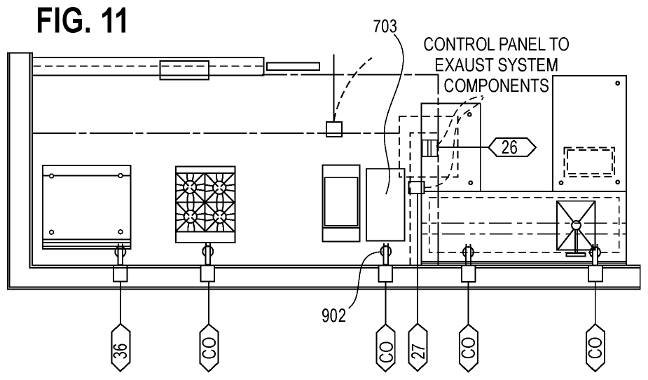

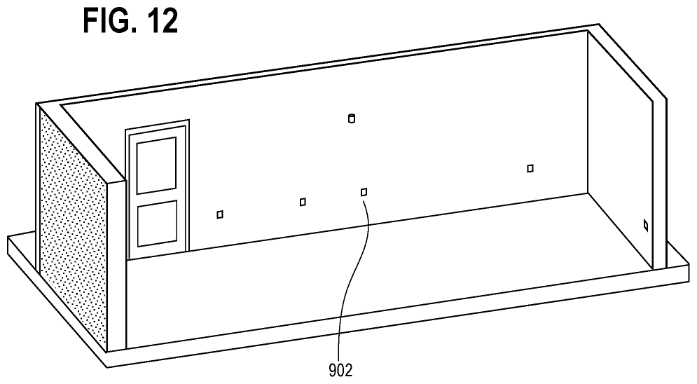

FIG. 9 depicts the electrical layout for a portion of the layout design for the kitchen discussed above. FIG. 10, in turn, depicts the location of those electrical outlets with respect to both their height and lateral positioning. FIGS. 11 and 12 depicts the electrical layout for the same portion of the layout design for the kitchen following the above-described user modifications. Note, for example, that the aforementioned double-deck convection oven 702 has two corresponding electrical outlets denoted by reference numeral 901. Since the user's revisions to the design removed this double-deck convection oven 702, at block 204 of FIG. 2 the control circuit 101 automatically redacted the two electrical outlets 901 that corresponded to that double-deck convection oven 702. Note as well that the aforementioned filler table 703 has a corresponding electrical outlet denoted by reference numeral 902. To accommodate the changed position of this filler table 703, the control circuit 101 automatically moved that outlet to a new position to accommodate the new location of the filler table 703.

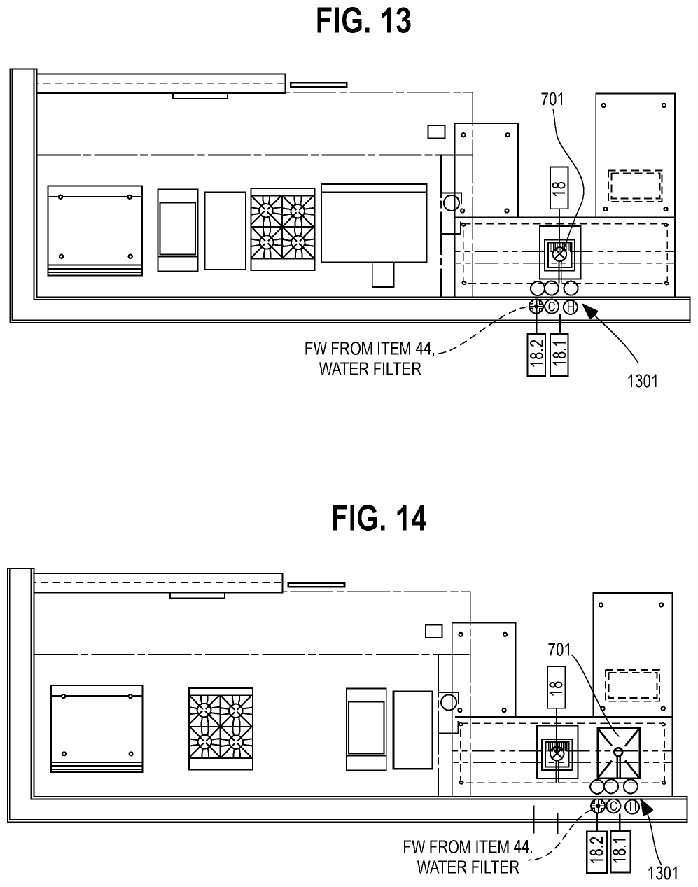

FIGS. 13 and 14 illustrate that the same automatic design updates can be applied for changes to the plumbing layout. As noted above, the user changed the location of the sink denoted by reference numeral 701. FIG. 13 shows the location of the plumbing connections 1301 prior to the user's revisions. FIG. 14 shows the moved location of these same plumbing connections 1301 that the control circuit 101 automatically makes to accommodate the new location of the sink 701.

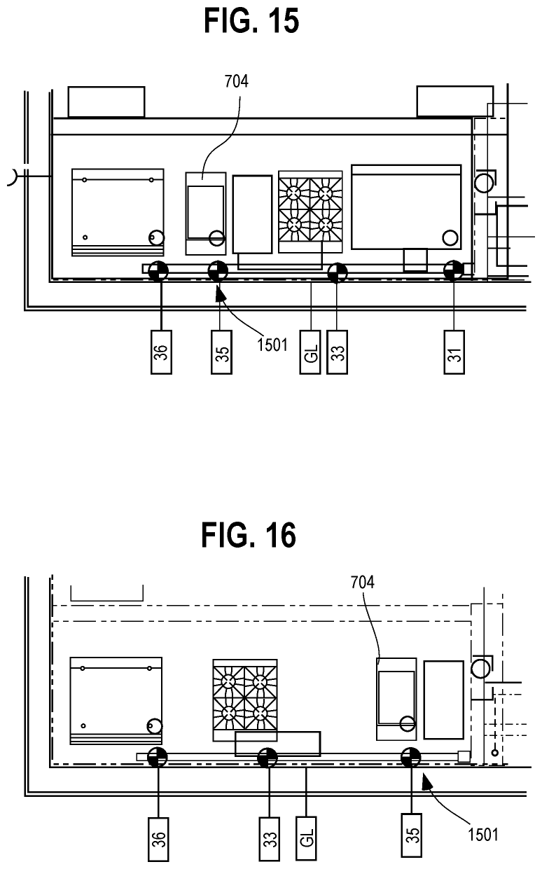

FIGS. 15 and 16 illustrate that the same automatic design updates can be applied for changes to the mechanical outlet (in particular, to the gas line). As noted above, the user changed the location of the deep fat gas fryer denoted by reference numeral 704. FIG. 15 shows the location of the gas line connection 1501 prior to the user's revisions. FIG. 16 shows the moved location of this same gas line connection 1501 that the control circuit 101 automatically makes to accommodate the new location of the deep fat gas fryer 704.

So configured, the kitchen designer is freed from the tedium of modifying extant layouts and specifications pertaining to electrical service, plumbing service, and mechanical service to accommodate changes with respect to appliances and fixtures. Such an approach can also help ensure accuracy and compliance with all relevant building and industry codes and practices.

With continued reference to FIG. 2, at optional block 206 this process will accommodate automatically selecting the orientation to apply for some or all of the aforementioned annotation tags, and in particular the orientation of the lead line that couples a particular annotation tag to a particular drawing element. See, for example, FIG. 5. In this presentation of the layout design of the kitchen the control circuit 101 has automatically located the annotation tags and their lead lines with respect to their corresponding design elements. The annotation tag denoted by reference numeral 503, for example, has been automatically positioned on the left side of its corresponding design element such that the lead line runs from the right side of the annotation tag 503. The annotation tag denoted by reference numeral 504, as another example, has been automatically positioned underneath its corresponding design element such that the lead line runs upwardly from the top side of the annotation tag 504. The annotation tag denoted by reference numeral 505 has been automatically positioned to the right of its corresponding design element such that the lead line runs from the left side of the annotation tag 505. And the annotation tag denoted by reference numeral 506 has been automatically positioned above its corresponding design element such that the lead line runs from the bottom side of the annotation tag 506.

By one approach, the control circuit 100 can be configured to decide where and how to place annotation tags by seeking to minimize the length of the lead line and the number of other lines (i.e., lines pertaining to architectural or design elements) that are crossed by the lead line. If desired, these teachings will accommodate having a preferred orientation (such as, for example, to the left of design elements or above the design elements) and then deviating from the preferred orientation when necessary to avoid a lead line having more than a preferred length or that crosses more than a preferred number of other lines.

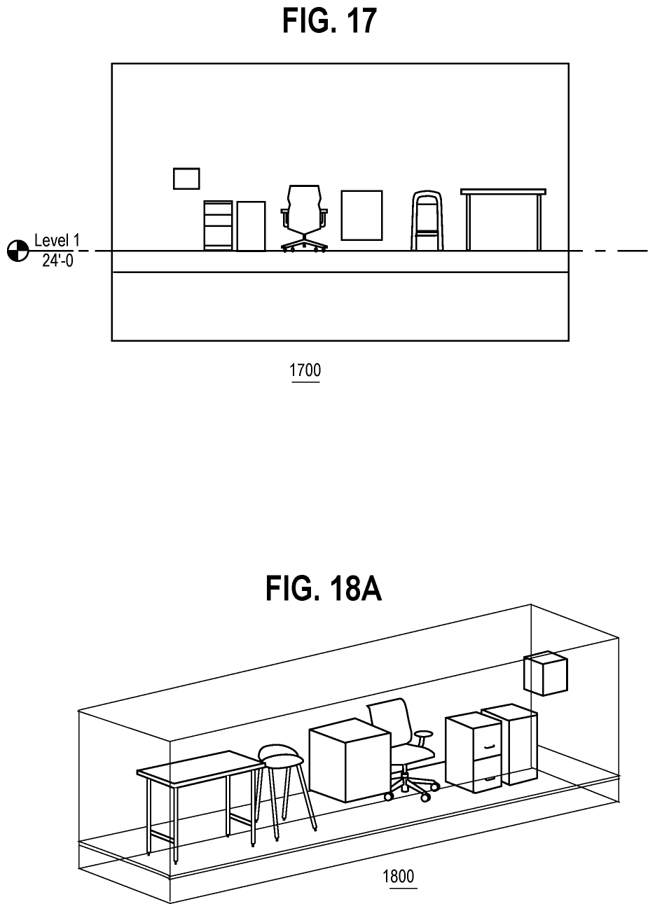

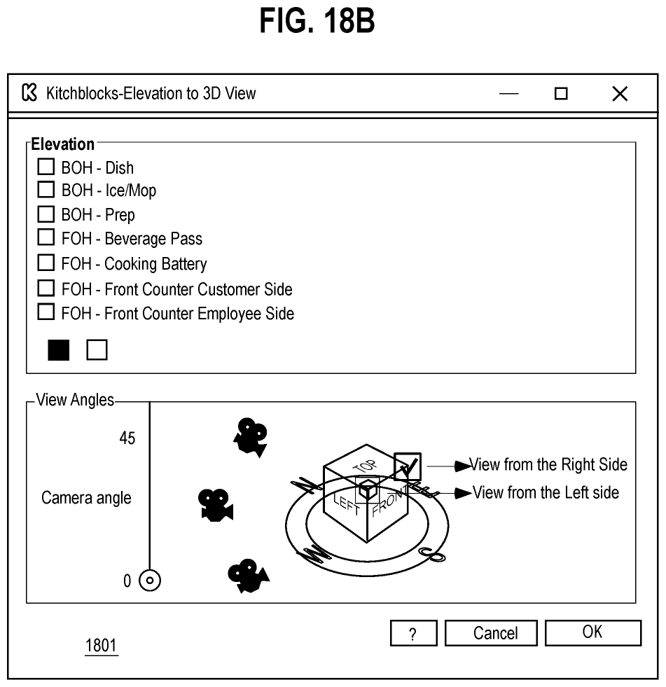

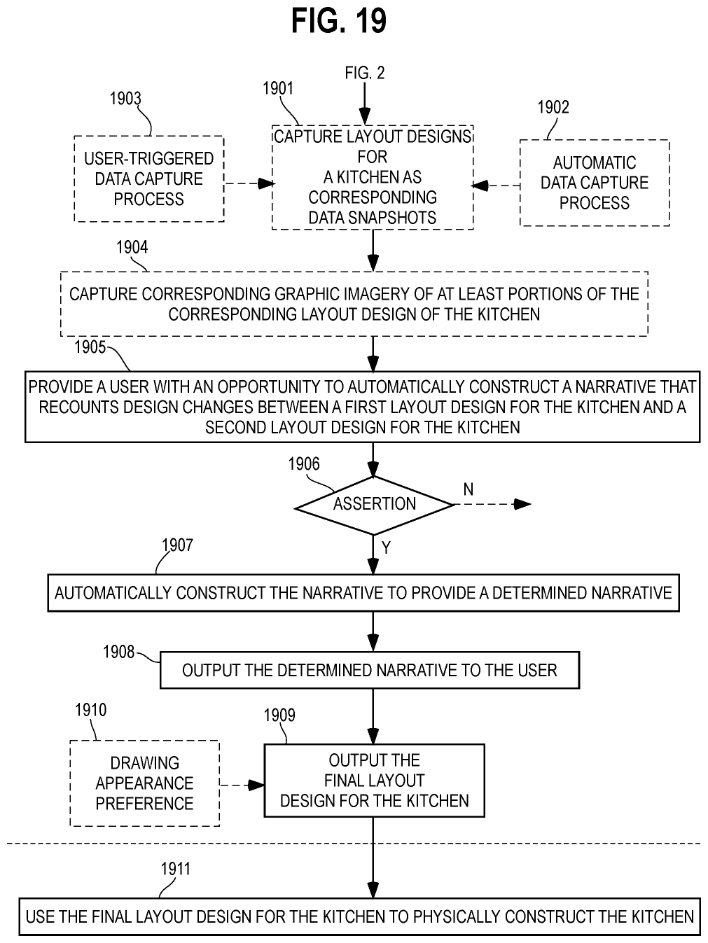

With reference now to FIGS. 2 and 17, at block 207 the control circuit 101 can detect a user's selection of a part of a two-dimensional view of a kitchen layout design. By one approach, and as an illustrative example, the user can make this selection by forming and sizing (and moving if necessary) a selection box on the display of the user interface 105. FIG. 17 presents such a selection as denoted by reference numeral 1700. At block 208 the control circuit 101 can then, in response to the aforementioned detection, automatically convert the selection (and only the selection) into a corresponding three-dimensional rendering. FIG. 18A presents an example of a three-dimensional rendering 1800 that corresponds to the selection 1700 shown in FIG. 17.

By one approach, if desired, the control circuit 101 can employ one or more previously-stored user presentation preferences 209 when converting the two-dimensional selection as described above. So configured, the resultant three-dimensional rendering can employ, for example, a preferred perspective angle, a preferred scaling factor, or any other preferred rendering parameter. FIG. 18B presents an illustrative example of a user-interface screen 1801 configured to provide the user with exemplary preference-selection opportunities.

As noted above, this process optionally accommodates the use of annotation tags which, in turn, can make use of numbers (or the like) by which design elements (such as particular appliances or fixtures) can be designated and tracked in a corresponding schedule. When assigning a particular number to a particular design element, a designer may wish to skip a next-in-sequence number for any number of reasons. Unfortunately, some CAD programs can be unforgiving in these regards and be unable to accept an unused number in this context.

With the foregoing in mind, at block 209 the control circuit 101 can detect such spare numbers and respond, at block 210, by automatically creating an invisible design element to correlate with such otherwise unassigned spare schedule numbers. Being “invisible,” the invisible design element will not appear in any renderings of the kitchen layout design, including two-dimensional and three-dimensional renderings thereof. Such an approach can readily accommodate the specific practice of creating and maintaining spare numbers without creating problems for the implementing CAD program.

The process shown in FIG. 2 can continue with the process shown in FIG. 19.

As shown at optional block 1901, the control circuit 101 can be configured to capture layout designs for a kitchen as corresponding data snapshots. These data snapshots can include, at least in part, design information regarding electrical layout and specifications, plumbing layout and specifications, mechanical layout and specifications, and appliance/fixture selections and locations (in addition, of course, to any relevant architectural details such as the location of walls, doors, windows, and the like). The resultant data snapshots can be stored, for example, in the aforementioned memory 102.

By one approach, and as illustrated at block 1902, the control circuit 101 captures these layout designs pursuant to an automatic data capture process. For example, the aforementioned data snapshots may be captured whenever the user “saves” a particular layout design. As another example, data snapshots may be automatically captured whenever more than a predetermined amount of time (such as 15 seconds or one minute) passes following the user having revised one or more design elements of a layout design for a kitchen. As yet another example, a data snapshot may be automatically captured on a periodic basis regardless of whether revisions have been made or other user actions have been taken. These examples are intended to serve an illustrative purpose and are not intended to suggest any particular limitations in these regards.

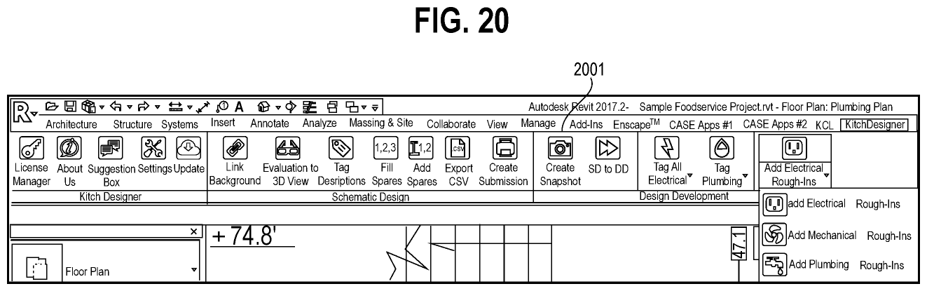

By another approach (in lieu of the foregoing or in combination therewith), and as illustrated at block 1903, the control circuit 101 may capture a layout design as a corresponding data snapshot in response to a user-triggered data capture process. For example, and referring momentarily to FIG. 20, a toolbar 2000 presented on the user interface 105 can include a button 2001 that, when asserted by the user, will trigger the design layout capture activity described above.

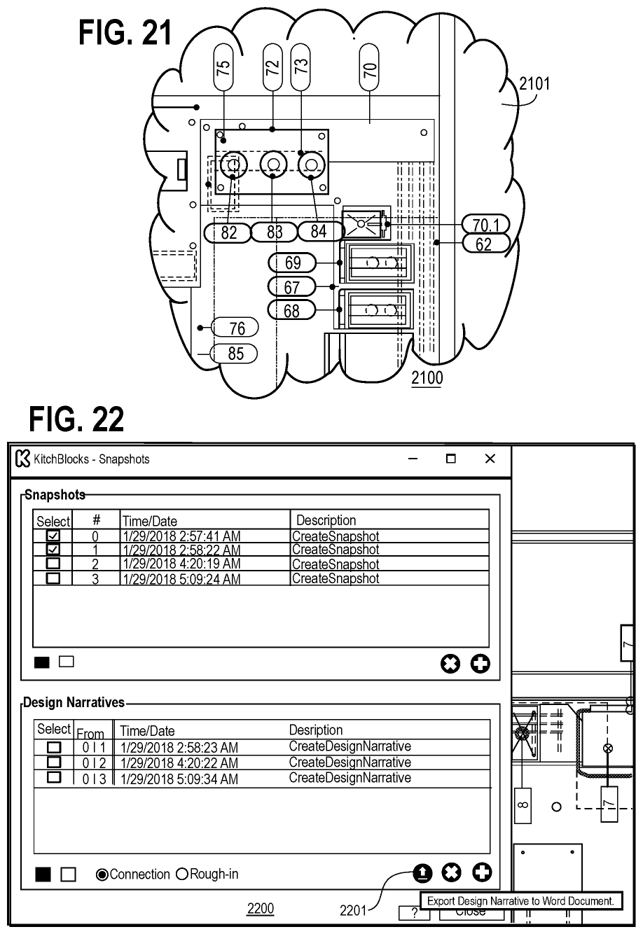

If desired, and as illustrated at block 1904, the control circuit 101 can also capture corresponding graphic imagery of at least portions of the corresponding layout design of the kitchen in response to the foregoing capture of a data snapshot. By one approach this graphic image comprises a thumbnail depiction using an image file format such as .jpg or .pdf. FIG. 21 provides an illustrative example of such a thumbnail depiction 2100. In this example the thumbnail serves to present only a portion of the overall layout design of the kitchen and, in particular, a portion that includes all or at least most of a portion of the layout design that includes a most recently made user revision. Highlighting can be utilized if desired to identify such revisions. This portion can be bounded by an appropriate periphery 2101 if desired to help communicate the fact that only a portion of the total design layout is depicted.

Referring now to FIGS. 19 and 22, at block 1905 this process has the control circuit 101 provide a user (via, for example, a corresponding window 2200 presented on a display of the user interface 105) with an opportunity to automatically construct a narrative that recounts design changes between a first layout design for the kitchen and a second layout design for the kitchen. In the illustrated example, the user is provided with an opportunity to select amongst four different data snapshots as described above (it being understood that there need be no particular limit to the number of different data snapshots that may be available for a given kitchen design). These data snapshots are presented in their order of creation and hence are in a temporal sequence. Per this process the user selects two (and only two) of these available data snapshots by checking two of the corresponding selection checkboxes. These teachings will accommodate selecting any two of the snapshots, regardless of how many snapshots there may be and regardless of how many snapshots may sequentially intervene between the two selected snapshots.

At block 1906 the control circuit 101 detects when the user has asserted the foregoing opportunity to automatically construct a narrative. With continued reference to FIG. 22, in this illustrative example the user can effect this assertion by asserting a corresponding button 2201 on the user interface.

At blocks 1907 and 1908 the control circuit 101, in response to the user having asserted the opportunity to automatically construct the narrative, automatically constructs a narrative to provide a determined narrative that can then be output to the user (via, for example, a display that comprises a part of the user interface 105 and/or the aforementioned printer 106). At a minimum, this narrative identifies and expresses design changes between the two selected snapshots which, in turn, constitute design changes between a first layout design for the kitchen that corresponds to the earlier-in-time snapshot and a second layout design for the kitchen that corresponds to the later-in-time snapshot. These design changes can constitute changes with respect to any of the electrical layout and specifications, the plumbing layout and specifications, or the mechanical layout and specifications, but in many application settings will refer (potentially exclusively) to appliance and fixture selections, deletions, and locations.

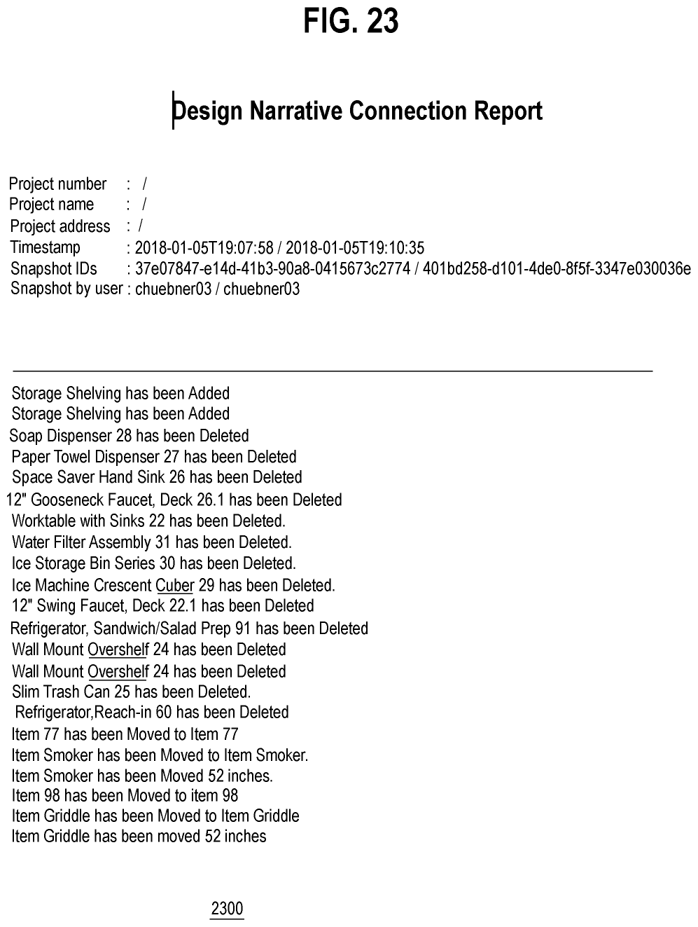

By one approach the narrative comprises a text-based narrative. FIG. 23 provides an example of a text-based design narrative connection report 2300 as an illustrative example in these regards. In this example the narrative identifies specific appliances/fixtures that have been added or deleted. In this example, the narrative is constrained to only noting the addition and deletion of appliances and fixtures and does not provide any information regarding changes to the corresponding electrical, plumbing, or mechanical layouts. If desired, the narrative-creation opportunity can be configured to permit the user to select, categorically, which design changes should be included in the narrative to thereby permit the user to include or exclude, for example, electrical layout revisions, plumbing layout revisions, and/or mechanical layout revisions.

The narrative can be accompanied by other content as desired. By one approach, for example, the corresponding thumbnail images described above can be included in the narrative. As another example, relevant metadata pertaining to the data snapshots can be included as appropriate. For example, this metadata may identify the persons and/or entities that were participating in a particular round of design revisions. In such a case those names can be included in the narrative to help identify which changes were undertaken or approved by which persons/entities.

The narrative can be formatted using any desired format. For many application settings it may be helpful to use a word processing format such as Word. As shown in FIG. 22, such narratives can be made available for selection by the user in a convenient submenu. For the sake of an illustrative example, it is presumed here that the snapshots are JSON files with a .snapshot file suffix, the design narratives are JSON files with a .dn suffix, and that the process serializes the JSON file(s) into a .docx file when exporting the narrative to Microsoft Word.

An illustrative example of a such an exported narrative is presented as follows:

### Design Narrative RoughIn Report

Project number: /
Project name: /
Project address: /
Timestamp: 2017-12-28T05:20:42/2017-12-28T05:26:45
Snapshot IDs: 5c9733bd-31a5-4a19-9069-ff31499de280/53bdaed8-c34e-49fe-9e48-2355bacc8f6c
Snapshot by user: chuebner03/chuebner03
Bun Pan Rack 18.1 has been Added.
Fire Extinguisher 100 has been Added.
Room Temperature Sensor has been Added.
Soap Dispenser has been Added.
Paper Towel Dispenser has been Added.
Space Saver Hand Sink 99 has been Added.
12″ Gooseneck Faucet, Deck has been Added.
Direct Drain 98 has been Added.
Double Pantry Faucet 99 has been Added.
Gas Valve 100 has been Added.
Food Processor 26 has been Deleted.
Ingredient Bin 27 has been Deleted.
Soap Dispenser 23 has been Deleted.
Paper Towel Dispenser 22 has been Deleted.
Space Saver Hand Sink 21 has been Deleted.
12″ Gooseneck Faucet, Deck 21.1 has been Deleted.
Hot Water 16 has been Deleted.
Direct Drain 21 has been Deleted.
Double Pantry Faucet 21.1 has been Deleted.
Gas Valve 64 has been Deleted.
[Id: 13414199] Gas Fryer [Mark: 61] has been changed to Gas Fryer [Mark: 61]
[Id: 13414199] Gas Fryer has been moved 55 inches.
[Id: 13414215] Table Filler [Mark: 59] has been changed to Table Filler [Mark: 59]
[Id: 13414215] Table Filler has been moved 23 inches.

[Id: 13414216] French Fry Warmer [Mark: 60] has been changed to French Fry Warmer [Mark: 60]
[Id: 13414216] French Fry Warmer has been moved 23 inches.
[Id: 13432864] Convection Oven [Mark: 58] has been changed to Convection Oven [Mark: 58]
[Id: 13432864] Convection Oven has been moved 33 inches.
[Id: 13444410] Combi Oven, Gas [Mark: 57] has been changed to Combi Oven, Gas [Mark: 57]
[Id: 13444410] Combi Oven, Gas has been moved 32 inches.
[Id: 13832137] Ingredient Bin [Mark: 28] has been changed to Ingredient Bin [Mark: 28]
[Id: 13832137] Ingredient Bin has been moved 8 inches.
[Id: 14217782] Filtered Water [Mark: 57] has been changed to Filtered Water [Mark: 57]
[Id: 14217782] Filtered Water has been moved 30 inches.
[Id: 14413664] Filtered Water [Mark: 57] has been changed to Filtered Water [Mark: 57]
Id: 14413664] Filtered Water has been moved 30 inches.
[Id: 14372471] Floor Sink [Mark: FS4] has been changed to Floor Sink [Mark: FS4]
[Id: 14372471] Floor Sink has been moved 20 inches.
[Id: 14217809] Gas Valve [Mark: 61] has been changed to Gas Valve [Mark: 61]
[Id: 14217809] Gas Valve has been moved 55 inches.

It should be noted that a given data snapshot may, or may not, include updated mechanical, electrical, and/or plumbing design layout content. In particular, while a given data snapshot may include changes regarding which appliances are included in the design and/or the location of such appliances, the user and/or the process may not have also updated the corresponding mechanical, electrical, and/or plumbing design layouts to accommodate such changes regarding the appliances. To accommodate such a circumstance, by one approach these teachings will accommodate automatically updating the corresponding mechanical/electrical/plumbing design changes and/or providing the user with an opportunity (in conjunction with the narrative-creation opportunity and/or result) to prompt the system to automatically update those corresponding changes to the mechanical design layout, electrical design layout, and/or the plumbing design layout.

Eventually, presumably, the layout design for the kitchen becomes a final layout design for the kitchen by virtue of, for example, receiving final approval by all authorized persons and entities. At this point, and as indicated at block 1909, the control circuit 101 outputs the final layout design for the kitchen. This can include but is not limited to locally or remotely printing part or all of the final layout design for the kitchen and/or retaining or forwarding a digital version of the final layout design for the kitchen as such.

By one optional approach, the control circuit 101 can use one or more drawing appearance preferences 1910 to inform the appearance of the final layout design for the kitchen. The latter can comprise, for example, automatically accessing stored information regarding those drawing appearance preferences as stored in the above described memory 102. These preferences can represent the preferences of a single individual, a team of individuals, a business, scholastic, or other affinity-based entity, the customer, and so forth. Examples of appearance preferences include but are not limited to preferences regarding visibility, font, line style, and annotation tags.

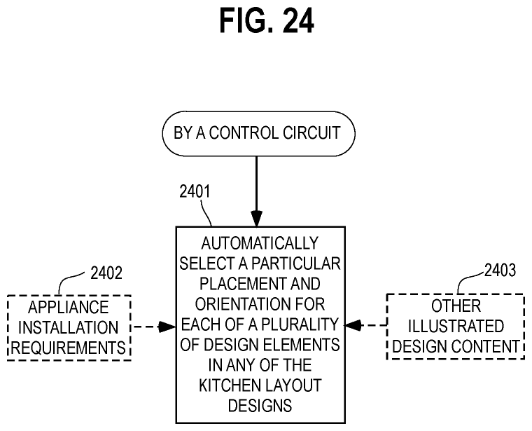

These teachings are highly flexible in practice and will accommodate various modifications and supplemental features. As but one illustrative example in these regards, and referring now to FIG. 24, the control circuit 101 can be configured to automatically select a particular placement and orientation for each of a plurality of design elements in a kitchen layout design as shown at block 2401. By one approach, the control circuit 101 is configured to place and orient a particular design element in a way such that the placement and orientation can vary from one design element to another in a single kitchen design layout.

As an illustrative example, this placement and orientation can be effected by determining a particular placement for a particular appliance, at least in part, by automatically calculating a distance between the appliance and at least one nearby wall for each of the plurality of design elements in the corresponding kitchen layout design. By another approach, in lieu of the foregoing or in combination therewith, this placement and orientation can be effected as a function, for example, of appliance installation requirements 2402 such as but not limited to electrical layout and specifications for a particular appliance, plumbing layout and specifications for a particular appliance, and/or mechanical layout and specifications for a particular appliance. By yet another approach, in lieu of the foregoing or in combination therewith, this placement and orientation can be effected as a function of other illustrated design content.

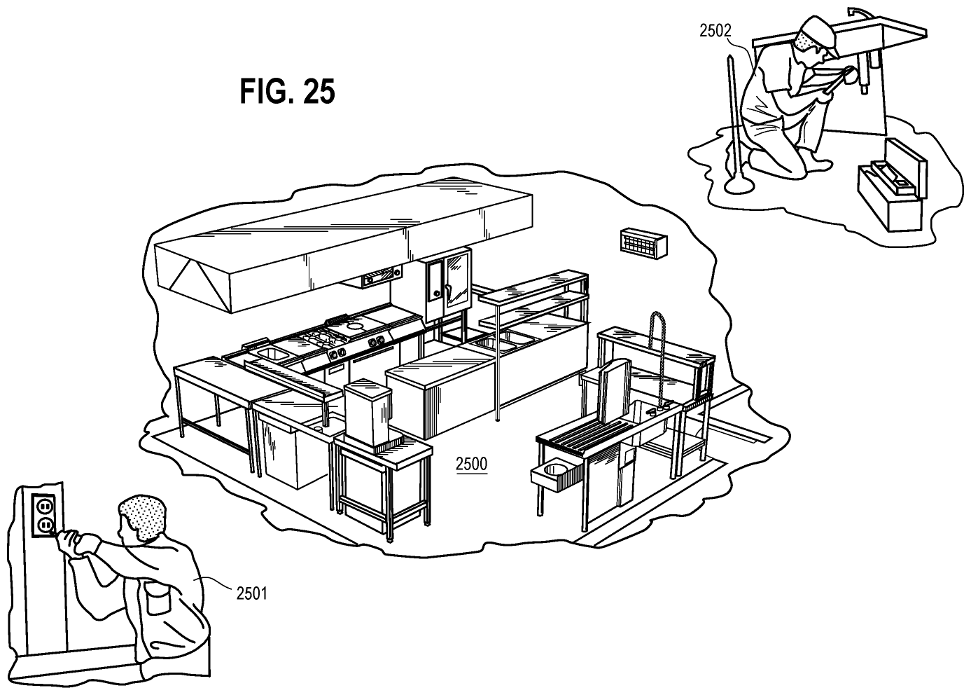

Any or all of the foregoing steps can be performed, in whole or in part, by the above-described control circuit 101 as desired. With continued reference to FIG. 19 and also to FIG. 25, in a typical application setting the control circuit 101 does not serve to physically construct the designed kitchen. Instead, as illustrated at block 1911 and FIG. 25, trained persons (including employees and/or third-party contractors as desired) such as the illustrated electrician 2501 and plumber 2502 use the final layout design for the kitchen as provided by the control circuit 101 to physically construct the kitchen 2500. These physical actions include, for example, placing and installing appliances and fixtures per the final layout design for the kitchen, routing and installing electrical outlets, connections, switches and other elements per the final layout design for the kitchen, routing and installing plumbing connections per the final layout design for the kitchen, and routing and installing various mechanical elements (such as natural gas connections, pneumatic ductwork, and so forth) per the final layout design for the kitchen.

So configured, these teachings can speed up the kitchen design process while enhancing rather than detracting from accuracy and various relevant requirements and specifications. In addition, these teachings can help ensure that the various often-complicated electrical, plumbing, and mechanical layout for a modern commercial/industrial kitchen is both suitable and correct without requiring or risking post-installation corrections in those regards.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A method of constructing a kitchen in accordance with a final layout design for the kitchen, the method comprising:
by a control circuit:
providing a user with an opportunity to automatically construct a narrative that recounts design changes between a first layout design for the kitchen and a second layout design for the kitchen;
upon detecting the user's assertion of the opportunity, automatically constructing the narrative to provide a determined narrative;
outputting the determined narrative to the user; and
outputting the final layout design for the kitchen; and
using the final layout design for the kitchen to physically construct the kitchen.

2. The method of claim 1 wherein the narrative comprises a text-based narrative.

3. The method of claim 1 wherein neither the first layout design nor the second layout design for the kitchen comprises the final layout design.

4. The method of claim 1 wherein the second layout design for the kitchen comprises the final layout design.

5. The method of claim 1 further comprising:
by the control circuit:
capturing the first layout design and the second layout design for the kitchen as corresponding data snapshots;
and wherein automatically constructing the narrative comprises, at least in part, detecting differences between the data snapshot for the second layout design for the kitchen with the data snapshot for the first layout design for the kitchen.

6. The method of claim 5 further comprising:
by the control circuit:
capturing at least a third layout design for the kitchen as a corresponding data snapshot;
and wherein providing the user with the opportunity to automatically construct the narrative includes presenting the user with an opportunity to select the first and second data snapshots from amongst a group of candidate data snapshots that includes the data snapshots for the first, second, and third layout designs for the kitchen.

7. The method of claim 5 wherein the control circuit captures the first layout design and the second layout design for the kitchen as corresponding data snapshots per at least one of:
a user-triggered data capture process; and
an automatic data capture process.

8. The method of claim 5 further comprising:
by the control circuit:
in conjunction with capturing the data snapshots, also capturing corresponding graphic imagery of at least portions of the corresponding layout design of the kitchen such that each of the data snapshots has a corresponding one of the graphic images.

9. The method of claim 1 wherein the layout designs for the kitchen include, at least in part, design information regarding electrical layout and specifications, plumbing layout and specifications, mechanical layout and specifications, and appliance selections and locations.

10. The method of claim 1 further comprising:
by the control circuit:
providing an automatic design update opportunity by which a user can cause the control circuit to automatically add layout design revisions to a kitchen layout design to accommodate user-based layout design revisions to the kitchen layout design.

11. The method of claim 10 wherein the layout design revisions to be automatically added to the kitchen layout design comprise at least one of electrical layout revisions, plumbing layout revisions, and mechanical layout revisions.

12. The method of claim 1 further comprising:
by the control circuit:
automatically accessing stored information regarding drawing appearance preferences and using the drawing appearance preferences when presenting the final layout design for the kitchen.

13. The method of claim 12 wherein the appearance preferences include at least some of preferences regarding visibility, font, line style, and annotation tags.

14. The method of claim 1 further comprising:
by the control circuit:
automatically selecting a particular orientation for each of a plurality of annotation tags in any of the kitchen layout designs as a function, at least in part, of other illustrated design content, such that orientation of the annotation tags can vary from one annotation tag to another in a single kitchen layout design.

15. The method of claim 1 further comprising:
by the control circuit:
accessing architectural design plans for the kitchen;
correlating elevational level information from the architectural design plans for the kitchen with elevational level information for the layout design plans for the kitchen.

16. The method of claim 15 wherein the control circuit accesses the architectural design plans for the kitchen by extracting the elevational level information without fully opening a file that includes the architectural design plans.

17. The method of claim 1 further comprising:
by the control circuit:
detecting a user's selection of a part of a 2-dimensional view of a kitchen layout design;
automatically converting the selection into a corresponding 3-dimensional rendering using previously-stored user presentation preferences.

18. The method of claim 17 wherein the previously-stored user presentation preferences include at least a preferred perspective viewing angle.

19. The method of claim 1 further comprising:
by the control circuit:
automatically selecting a particular placement and orientation for each of a plurality of design elements in any of the kitchen layout designs as a function, at least in part, of at least one of:
appliance installation requirements; and
other illustrated design content;
such that placement and orientation of the design elements can vary from one design element to another in a single kitchen design layout.

20. The method of claim 19 wherein the design elements in any of the kitchen layout designs include, at least in part, installation information regarding electrical layout and specifications, plumbing layout and specifications, and mechanical layout and specifications.

21. The method of claim 19 wherein the particular placement is determined, at least in part, by automatically calculating a distance between a given appliance and at least one nearby wall for each of the plurality of design elements in any of the kitchen layout designs.
